(19) United States
(12) Patent Application Publication
(10) Pub. No.: US 2021/0182894 A1
(43) Pub. Date: Jun. 17, 2021

(54) SALES PROMOTION SYSTEM

(71) Applicant: TOSHIBA TEC KABUSHIKI KAISHA, Tokyo (JP)

(72) Inventor: Kazuyoshi Shimoda, Tagata Shizuoka (JP)

(21) Appl. No.: 17/030,880

(22) Filed: Sep. 24, 2020

(30) Foreign Application Priority Data
Dec. 17, 2019 (JP) 2019-227145

(51) Int. Cl. G06Q 30/02; G06K 9/00

(52) U.S. Cl. CPC G06Q 30/0223; G06K 9/00744; G06Q 30/0238; G06Q 30/0224

(57) ABSTRACT

According to one or more embodiments, a sales promotion system includes a sales promotion sever configured to identify a product at a sales floor location as a purchase-desired commodity for a customer based on movements of the customer on a sales floor during shopping and provide sales promotion information related to the purchase-desired commodity to the customer while the customer is at the sales floor location

### CROSS-REFERENCE TO RELATED APPLICATIONS

This application is based upon and claims the benefit of priority from Japanese Patent Application No. 2019-227145, filed on Dec. 17, 2019, the entire contents of which are incorporated herein by reference.

### FIELD

Embodiments of the invention relate generally to a sales promotion system.

### BACKGROUND

A retail store system, in which a cart terminal is attached to a shopping cart and operated by a shopper to input commodity data for purchase, is known. Such a system simplifies commodity purchase transactions.

In such a store system, sales promotions (e.g., advertisements) may be displayed to the shopper via a display device of the cart terminal. The sales promotion information may be associated with a product which the shopper has already registered for purchase at the cart terminal.

However, a customer does not necessarily have an interest in products/promotions related to the already-registered item(s).

### BRIEF DESCRIPTION OF THE DRAWINGS

FIG. 1 depicts a sales promotion system according to an embodiment.

FIG. 2 is a block diagram of a circuit configuration of a cart terminal of a sales promotion system according to an embodiment.

FIG. 3 is a block diagram of a circuit configuration of a moving line tracking device of a sales promotion system according to an embodiment.

FIG. 4 depicts an example data structure of a flow line file according to an embodiment.

FIG. 5 is a block diagram of a circuit configuration of a sales promotion server of a sales promotion system according to an embodiment.

FIG. 6 depicts an example data structure of a commodity record according to an embodiment.

FIG. 7 depicts an example data structure of a coupon record according to an embodiment.

FIG. 8 depicts an example of a coupon image according to an embodiment.

FIG. 9 depicts an example data structure of an association table according to an embodiment.

FIG. 10 is a block diagram of a circuit configuration of a virtual POS server of a sales promotion system according to an embodiment.

FIG. 11 depicts an example data structure of a transaction information file according to an embodiment.

FIG. 12 is a flowchart of information processing according to an embodiment.

FIG. 13 is a flowchart of coupon processing according to an embodiment.

### DETAILED DESCRIPTION

According to one or more embodiments, a sales promotion system includes a sales promotion sever with a first processor configured to identify a product at a sales floor location as a purchase-desired commodity for a customer based on movements of the customer on a sales floor during shopping and provide sales promotion information related to the purchase-desired commodity to the customer while the customer is at the sales floor location. a sales promotion system includes a processor configured to predict a purchase-desired commodity from an action of a customer during shopping and provide sales promotion information related to the purchase-desired commodity.

Hereinafter, one or more embodiments of a sales promotion system will be described with reference to the drawings.

In one embodiment, a sales promotion system is configured to facilitate promotion of sales by issuing a coupon of a product or item (commodity) for which it can be inferred that the customer is in interested or considering for purchase according to customer movements of the shopping cart about the store. Hereinafter, the shopping cart may be referred to as a cart for simplicity. A customer may also be referred to as a shopper, a consumer, or a member depending on context.

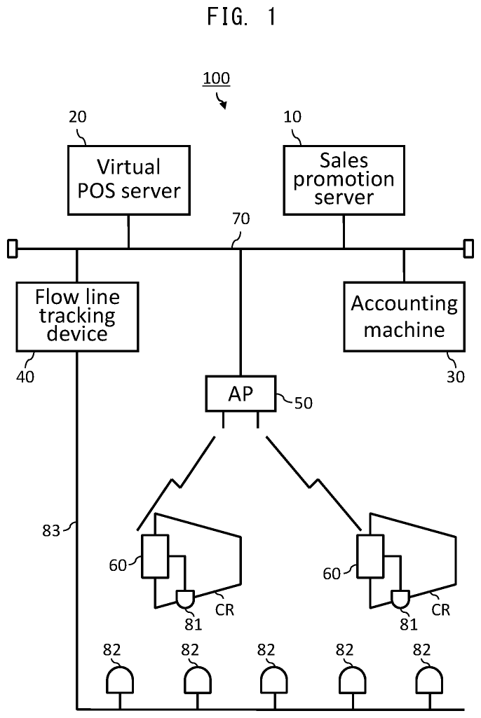

FIG. 1 is a schematic configuration diagram of a sales promotion system 100 according to the present embodiment. The sales promotion system 100 includes a sales promotion server 10, a virtual Point of Sale (POS) server 20, an accounting machine 30, a flow line tracking device 40 (also referred to as a tracking device 40 for simplicity), an access point 50, a cart terminal 60, and a communication network 70. The communication network 70 is a wired Local Area Network (LAN). The communication network 70 connects the sales promotion server 10, the virtual POS server 20, the accounting machine 30, the tracking device 40 and the access point 50. The communication network 70 may be a wireless LAN.

The access point 50 is a device that constitutes a wireless LAN together with the cart terminal 60. The access point 50 serves as a relay site for data transmission between the cart terminal 60 connected by the wireless LAN and various devices connected by the wired LAN. The number of access points 50 is not limited to one. Two or more access points 50 may be connected to the communication network 70 depending on, for example, a scale or a size, a layout, and the like of a store.

The cart terminal 60 is a portable electronic device for supporting customer's shopping at a store where the sales promotion system 100 is installed. The cart terminal 60 is attached to a cart CR.

A customer who is shopping with a cart CR operates the cart terminal 60. The cart terminal 60 may also be referred to as a consumer or customer terminal herein.

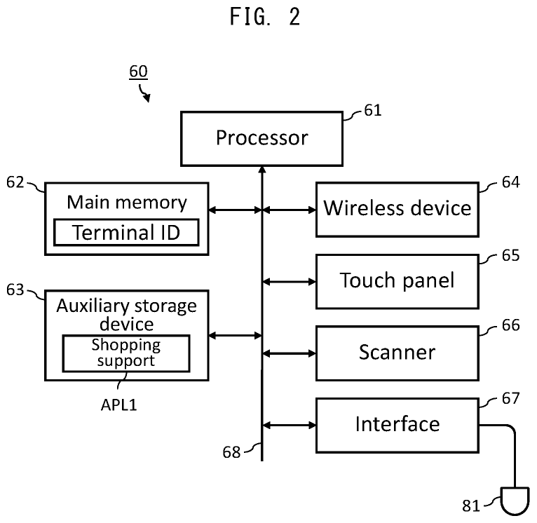

FIG. 2 is a block diagram illustrating a circuit configuration of the cart terminal 60 according to the present embodiment. The cart terminal 60 includes a processor 61, a main memory 62, an auxiliary storage device 63, a wireless device 64, a touch panel 65, a scanner 66, an interface 67, and a system transmission line 68. The system transmission line 68 includes an address bus, a data bus, a control signal line, and the like. The cart terminal 60 connects the processor 61, the main memory 62, the auxiliary storage device 63, the wireless device 64, the touch panel 65, the scanner 66, and the interface 67 to the system transmission line 68. In the cart terminal 60, a computer is configured by the processor 61, the main memory 62, and the auxiliary storage device 63 as well as the system transmission path 68 connecting these components with each other.

The processor 61 is a central part of the computer. The processor 61 controls each unit or component to realize various functions as the cart terminal 60 according to an operating system or an application program. The processor 61 is, for example, a central processing unit (CPU).

The main memory 62 is a main storage portion of the computer. The main memory 62 includes a non-volatile memory area and a volatile memory area. The main memory 62 stores an operating system or an application program (or application programs) in the non-volatile memory area. The main memory 62 stores data necessary for the processor 61 to execute processes for controlling each unit in the volatile memory area. The data may be stored in the non-volatile memory area. The main memory 62 uses the volatile memory area as a work area in which data is appropriately rewritten by the processor 61. The non-volatile memory area is, for example, a read only memory (ROM). The volatile memory area is a random-access memory (RAM), for example.

The auxiliary storage device 63 is an auxiliary storage portion of the computer. For example, an electric erasable programmable read-only memory (EEPROM), a hard disc drive (HDD), a solid-state drive (SSD), or the like may be the auxiliary storage device 63. The auxiliary storage device 63 stores data to be used by the processor 61 for performing various types of processing, data generated by processing in the processor 61, and the like. The auxiliary storage device 63 may also store the application programs.

The wireless device 64 is a device for performing wireless communication of data with the access point 50 connected by a wireless LAN.

The touch panel 65 is a device having both an input device and a display device of the cart terminal 60. The touch panel 65 displays a variety of images. The touch panel 65 detects a touch position with respect to a displayed image and outputs touch position information to the processor 61.

The scanner 66 is a device used for reading a barcode. The scanner 66 may be a device that optically reads an optical barcode by scanning with a laser beam, or a device that processes an image including a barcode captured by a camera to read a barcode.

The interface 67 connects a beacon transmitter 81 via a communication cable or the like. The beacon transmitter 81 is a device that periodically transmits a signal (called a beacon) by using a short-range wireless technology such as Bluetooth®. The beacon includes a unique terminal ID set for each cart terminal 60 in order to individually identify each cart terminal 60. The terminal ID is preset in the non-volatile memory area of the main memory 62.

In the cart terminal 60, a shopping support program APL 1 is installed in the auxiliary storage device 63. Installation of the shopping support program APL 1 in the auxiliary storage device 63 is not limited to any particular method or configuration. The shopping support program APL 1 can be recorded in a removable recording medium or can be distributed by communication via a network and installed in the auxiliary storage device 63. The recording medium may be of any type as long as it can store a program and can be read by an apparatus, a device, a processor, or the like, such as a CD-ROM, a memory card, or the like. The installation destination of the shopping support program APL 1 may be the main memory 62.

As shown in FIG. 1, the beacon transmitter 81 is attached to the cart CR along with the cart terminal 60. In a store where the sales promotion system 100 is installed, several beacon receivers 82 are arranged about the store at different locations. The beacon receiver 82 is a device for receiving a beacon emitted from the beacon transmitter 81 when the cart CR is within communication range.

Each beacon receiver 82 is disposed at different (but known) sales floor locations. The store can be divided in to different regions, positions, locations, areas, floors, and/or departments and beacon receivers 82 may be provided distinctly for each.

The sales floor locations can be divided into areas displaying just one product, type or category of products, or several different products, types or categories of products. The sales floor location may include a commodity shelf, a showcase, a display corner, a display rack, or the like. For example, a rack of one shelf or a plurality of shelves may be regarded as forming a sales floor location for which a beacon receiver 82 may be provided. Such a sales floor location may, for example, be a display for a particular type of commodity such as a vegetable, a confectionery or a daily use commodity. Such a rack may be referred to as a commodity shelf in some contexts. A display case accommodating and displaying various commodities such as fresh fish, meat, frozen desserts or the like may be regarded as a sales floor location and be referred to as a showcase in some instances. A space where, for example, clothes are hung on hangers or large-size commodities such as bicycles are displayed side by side may be regarded as a sales floor location and may be referred to as a display corner in some instances.

At least one beacon receiver 82 is arranged in an area designated as one sales floor location. In some instances, two or more beacon receivers 82 may be arranged in one sales floor location. Each beacon receiver 82 has position information. The position information indicates the sales floor location at which the beacon receiver 82 is disposed. For each sales floor location, a sales floor code is set in advance. The sales floor code is a unique identification code set for each sales floor location in order to individually identify each sales floor location. The position information includes the sales floor code. Upon receiving a beacon, the beacon receiver 82 outputs the position information together with the information of the beacon which includes the terminal ID. The information signals output from the respective beacon receivers 82 are sent to the tracking device 40 via a communication cable 83.

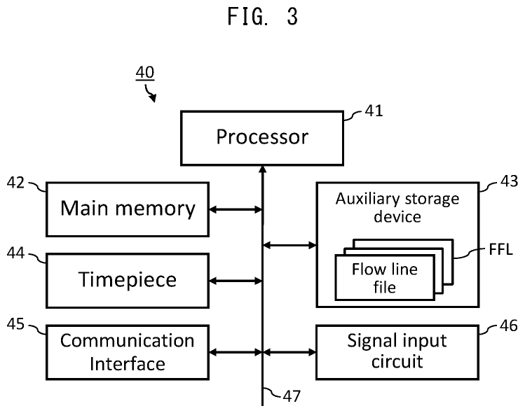

FIG. 3 is a block diagram illustrated a configuration of the flow line tracking device 40. The tracking device 40 includes a processor 41, a main memory 42, an auxiliary storage device 43, a timepiece 44, a communication interface 45, a signal input circuit 46, and a system transmission line 47. The system transmission line 47 includes an address bus, a data bus, a control signal line, and the like. The tracking device 40 is a computer comprising at least the processor 41, the main memory 42, and the auxiliary storage device 43 along with the system transmission line 47 that connects these components to each other.

Basic configurations, functions, and the like of the processor 41, the main memory 42, and the auxiliary storage device 43 are substantially the same as those of the processor 61, the main memory 62, and the auxiliary storage device 63 of the cart terminal 60, except that, for example, programs and data stored in the main memory 42 and/or the auxiliary storage device 43 and executed by the processor 41 are for the flow line tracking device 40 to perform the flow line tracking (customer movement tracking).

The timepiece 44 serves as a time information source for the tracking device 40. The processor 41 acquires the time counted by the timepiece 44 as the current time. The communication interface 45 is a circuit for performing data communication via the communication network 70. The signal input circuit 46 is a circuit for receiving information signals from each of the beacon receivers 82.

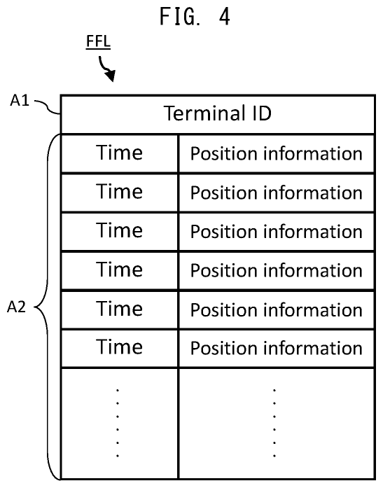

In the tracking device 40, a storage area for storing a plurality of flow line files FFL is formed in the auxiliary storage device 43. FIG. 4 illustrates an example data structure of a flow line file FFL. As illustrated, the flow line file FFL includes an area A1 for a terminal ID and an area A2 for the pieces of flow line data. Here, the flow line data includes time and position information. The different pieces of flow line data collectively represents the movement (flow) a cart CR on which the cart terminal 60 (identified by the terminal ID in the area A1) is attached. That is, as the cart CR is moved over time about the store from position to position, the corresponding pieces of flow data are collected at sufficient interval to track movement (flow) of the cart CR. The cart CR generally moves by being pushed by a shopper. Therefore, the flow line data also represents a flow line or a movement line of a shopper who uses the cart CR. The flow line data is in the flow line file FFL in descending time order. The time is obtained from the timepiece 44. The position information is obtained from the beacon receiver 82. The position information relates to a sales floor location or the like at which a beacon receiver 82 is installed. The flow line tracking device 40 functions as a tracking unit that tracks movements of a customer (more particularly in this example the cart CR associated with the customer) about the store from location to location.

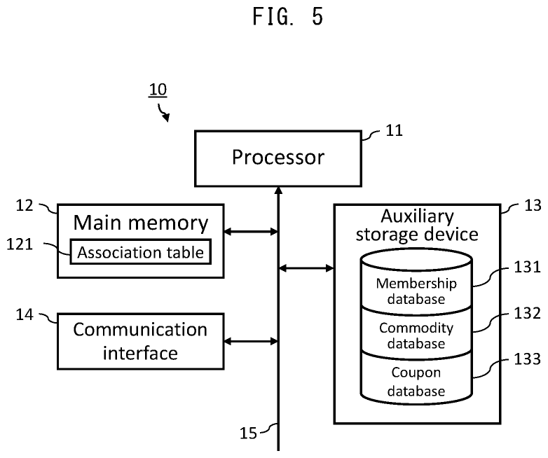

FIG. 5 illustrates a block diagram of a circuit configuration of the sales promotion server 10. The sales promotion server 10 includes a processor 11, a main memory 12, an auxiliary storage device 13, a communication interface 14, and a system transmission line 15. The system transmission line 15 includes an address bus, a data bus, a control signal line, and the like. The sales promotion server 10 connects the processor 11, the main memory 12, the auxiliary storage device 13, and the communication interface 14 to the system transmission line 15. In the sales promotion server 10, a computer is configured by the processor 11, the main memory 12, and the auxiliary storage device 13 as well as the system transmission line 15 connecting these components to each other.

Basic configurations, functions, and the like of the processor 11, the main memory 12, and the auxiliary storage device 13 are substantially the same as those of the processor 61, the main memory 62, and the auxiliary storage device 63 of the cart terminal 60, except that, for example, programs and data stored in the main memory 12 and/or the auxiliary storage device 13 and executed by the processor 11 are for the sales promotion server 10 to perform the sales promotion.

The communication interface 14 is a circuit for performing data communication with the respective units connected via the communication network 70.

The auxiliary storage device 13 includes a membership database 131, a commodity database 132, and a coupon database 133. Part of the volatile memory area in the main memory 12 is referred to as an association table 121.

The membership database 131 is an aggregation of membership records describing data relating to a customer who has completed membership registration for using the cart terminal 60. Such a customer may be called a member. A member record includes data items such as a member ID, a gender, an age, a cumulative rewards or purchase points, and the like. The member ID is a unique identification code that is set for each member. Gender and age reflect the information provided by or known about the member. The cumulative rewards or purchase points reflect he accumulated points given to the member on the basis of, for example, a total transaction amount in all commercial transactions by the member at the store or the like.

A membership card can be issued to a member. A barcode indicating a member ID of the member can be displayed on the membership card. In addition, data indicating a member ID of the member card can be stored in a memory chip of the member card. The membership card may be an electronic card that is displayed by a dedicated application program (an app) installed in an information terminal of the customer/member such as a smartphone. In the case of an electronic card, a barcode indicating a member ID can be displayed on a display device of the information terminal as needed.

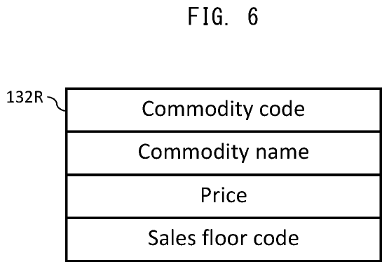

The commodity database 132 is an aggregate of commodity records 132R (see FIG. 6) including data about each commodity sold in the store. FIG. 6 illustrates an example data structure of the commodity record 132R. As illustrated, the commodity record 132R includes data items such as a commodity code, a commodity name, a price, a sales floor code and the like. The commodity code is a unique identification code that is set for each commodity. A barcode or the like indicating the commodity code is attached to each commodity. The sales floor code is an identification code of the sales floor location at which, the commodity identified by the commodity code is displayed/stored. The commodity database 132 stores information indicating a sales location for each commodity.

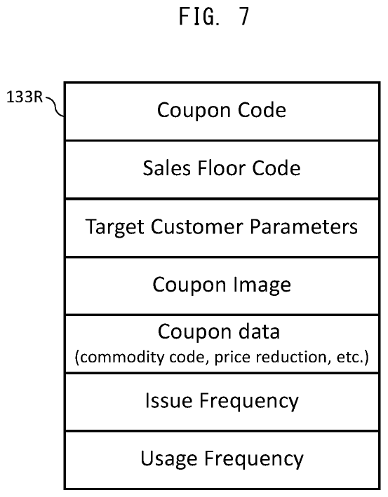

The coupon database 133 is an aggregate of coupon records 133R (see FIG. 7) including data about coupons that can be used for a price reduction or a price discount of a commodity. FIG. 7 illustrates an example data structure of the coupon record 133R. As illustrated, the coupon record 133R includes entries for a coupon code, a sales floor code, target customer parameters, a coupon image, coupon data, an issue frequency and a usage frequency. The coupon code is a unique identification code that has been set for each coupon to identify a coupon individually. The sales floor code is an identification code of a sales floor location where the commodity to which a price reduction or a price discount is being applied by the coupon is displayed. The target customer parameters represent the customer categories (based demographic or other information) to which the coupon is to be issued. The customer categories can divide the customer population by, for example, gender and age. The coupon image is image data representing the coupon. The issue frequency tracks how many times a coupon corresponding to the coupon code has been issued. The usage frequency tracks how many times an issued coupon (corresponding to the coupon code) has be used by a customer.

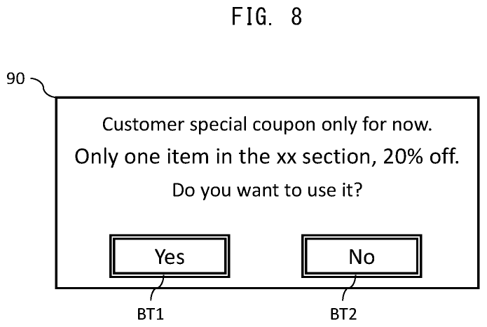

FIG. 8 illustrates an example of a coupon image 90. As illustrated, the coupon image 90 includes a message indicating a content of the coupon and button images BT1 and BT2 for selecting whether to use a coupon. The button images BT1 and BT2 are examples of operators that are reproduced on a screen by software. The coupon image 90 is typically displayed on the touch panel 65 of the cart terminal 60. A customer who wishes to use a coupon in the coupon image 90 touches the button image BT1 on which “Yes” is displayed. A customer who does not want to use the coupon touches the button image BT2 on which “No” is displayed.

The coupon data includes data of price reduction or price discount, and the data for identifying the commodity to which the price reduction or the price discount is to be applied. For example, in the coupon image 90 as shown in FIG. 8, “Only one item . . . , 20% off.” is included as the data of the price reduction or the price discount, and “ . . . in the xx section . . . ” is included as the data for specifying the commodity in the identified sales floor location.

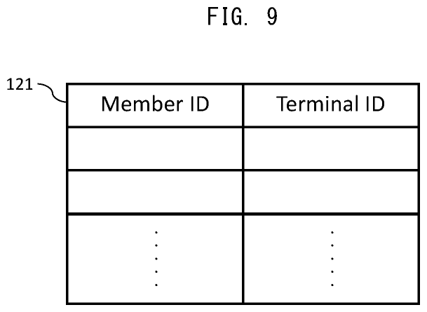

The association table 121 in the main memory 12 (FIG. 5) stores one member ID and one terminal ID in association with each other. FIG. 9 illustrates an example data structure of the association table 121. As illustrated, the association table 121 includes a field for a member ID and a field for a terminal ID. The processor 11 writes a membership ID and a terminal ID in the same row, thereby associating the membership ID with the terminal ID.

The virtual POS server 20 of the sales promotion system 100 cooperates with the cart terminal 60 (FIG. 1). The virtual POS server 20 thus permits the cart terminal 60 to operate for the customer much like a standard POS terminal already known to the customer. For example, the virtual POS server 20 performs registration processing of the items being purchased based on data input via the touch panel 65 or the scanner 66 of the cart terminal 60. The data corresponding to the registered items (commodities) can displayed on the touch panel 65 of the cart terminal 60 during the registration processing by the virtual POS server 20.

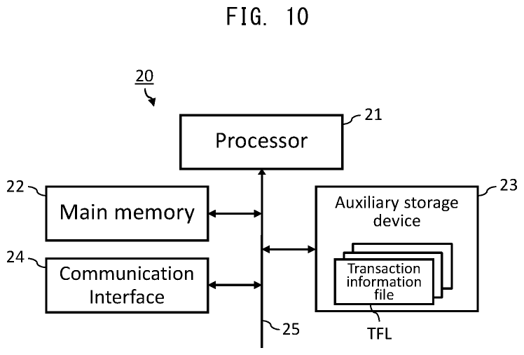

FIG. 10 illustrates a block diagram of a circuit configuration of the virtual POS server 20. The virtual POS server 20 includes a processor 21, a main memory 22, an auxiliary storage device 23, a communication interface 24, and a system transmission line 25. The system transmission line 25 includes an address bus, a data bus, a control signal line, and the like. The virtual POS server 20 connects the processor 21, the main memory 22, the auxiliary storage device 23, and the communication interface 24 to the system transmission line 25. In the virtual POS server 20, a computer is configured by the processor 21, the main memory 22, and the auxiliary storage device 23 as well as the system transmission line 25 that connects these components to each other.

Basic configuration, functions, and the like of the processor 21, the main memory 22, and the auxiliary storage device 23 are substantially the same as those of the processor 61, the main memory 62 and the auxiliary storage device 63 of the cart terminal 60, except that, for example, programs and data stored in the main memory 22 and/or the auxiliary storage device 23 and executed by the processor 21 are for the virtual POS server 20 to perform the virtual POS.

The communication interface 24 is a circuit for performing data communication with the respective units connected via the communication network 70.

The virtual POS server 20 forms, in the auxiliary storage device 23, a storage area for storing a plurality of transaction information files TFL.

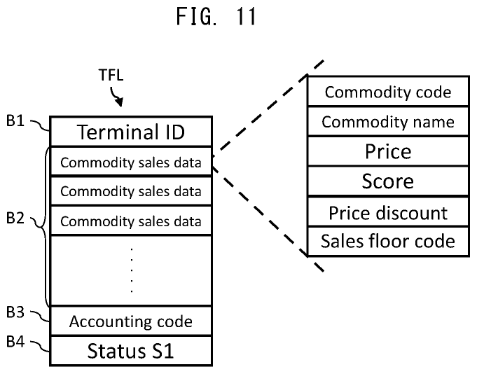

FIG. 11 illustrates an example data structure of the transaction information file TFL.

As illustrated, the transaction information file TFL includes an area B1 for describing a terminal ID, an area B2 for describing a plurality of pieces of commodity sales data, an area B3 for describing an accounting code, and an area B4 for describing a status S1.

The commodity sales data includes items data such as a commodity code, a commodity name, a price, a score, a price discount amount, a sales floor code, and the like. In the transaction information file TFL, commodity sales data for one transaction is stored. The accounting code is a unique code that is used to settle a transaction of commodity purchase or payment. The status S1 is information for identifying a status or a state of the transaction information file TFL, more particularly, a current status of the transaction particularly associated with the transaction information file TFL. The current status of the transaction reflects the progress through various stages of a sales transaction. The status in the transaction information file TFL is a first state before a start of a commodity registration, a second state after a start of the commodity registration, a third state after a start of settlement, and a fourth state after an end of settlement. In the present embodiment, the status S1 indicating the first state is set to “0”, the status S1 indicating the second state is set to “1”, the status S1 indicating the third state is set to “2”, and the status S1 indicating the fourth state is set to “3”.

The accounting machine 30 of the sales promotion system 100 (FIG. 1) is a terminal for settlement of a transaction. The accounting machine 30 acquires transaction data of the transaction from the virtual POS server 20 and settles the transaction based on the transaction data. The accounting machine 30 can settle one transaction by a settlement method such as cash settlement, credit card settlement, electronic money settlement, point settlement, code settlement (may also be referred to as mobile settlement or smartphone settlement), or the like.

The accounting machine 30 includes a manned accounting machine in which a clerk inputs information for settlement and a self-accounting machine in which a customer inputs information for settlement. The sales promotion system 100 may include both a manned accounting machine and a self-accounting machine or may include only one of them. The manned accounting machine may be, for example, a Point of Sale (POS) terminal or a cash register operated by a store clerk. The self-accounting machine may be, for example, a self-service Kiosk or a self-checkout terminal. A semi-self-type accounting machine may also be applied.

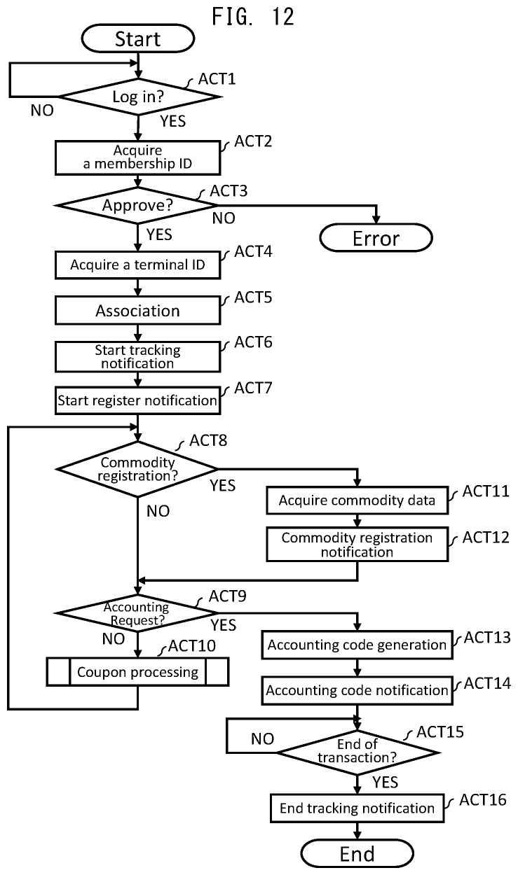

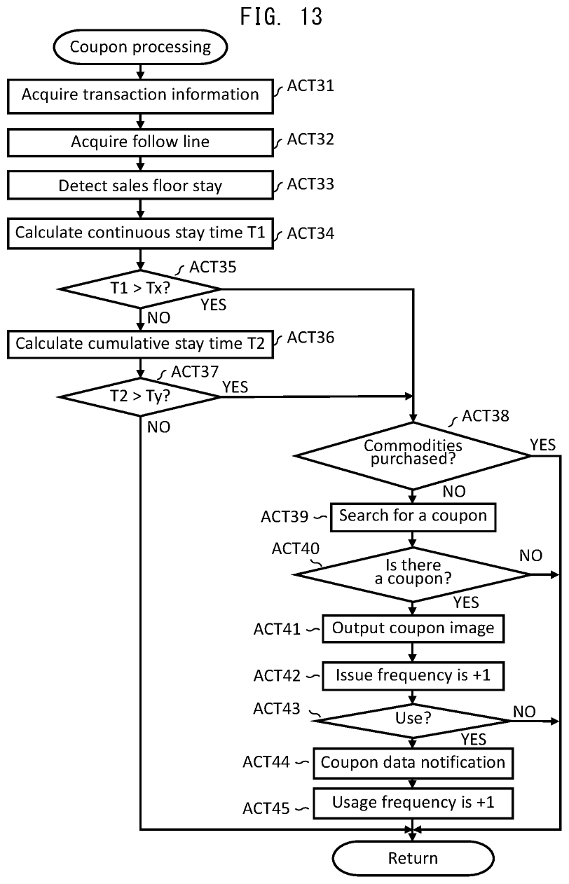

FIGS. 12 and 13 are flowcharts of information processing performed by the sales promotion system according to the present embodiment. Part or all of processes are performed according to one or more programs executed by processors of corresponding units or components of the sales promotion system, such as the processor 11 of the sales promotion server 10. Each flowchart is one example in the present embodiment and can be appropriately modified in some instances.

First, a person who has visited a store as a customer reserves a cart CR. Then, before starting shopping, the customer activates the cart terminal 60 attached to the cart CR. When the cart terminal 60 is activated, a login screen is displayed on the touch panel 65, and the customer logs in with his/her member ID. For example, the customer logs in by causing the scanner 66 to read a barcode of the member ID provided on a membership card or a barcode of the membership ID displayed on an information terminal such as a smartphone. Alternatively, if the cart terminal 60 is provided with a card reader, the customer logs in by using the card reader to read the data of the membership card.

A login command is transmitted from the cart terminal 60 on which the login has been performed, via the wireless device 64. The login command is received by the access point 50 connected by the wireless LAN and is transmitted to the sales promotion server 10 through the communication network 70. The login command includes a member ID input by a login operation.

The processor 11 of the sales promotion server 10 waits for the login command (ACT1). When the login command is received via the communication interface 14 (“YES” in ACT1), the processor 11 acquires the member ID from the login command (ACT2).

Then, the processor 11 determines whether to approve the shopping for which the customer identified by the member ID uses the cart terminal 60 (ACT3). For example, the processor 11 searches the membership database 131 to check whether a membership record including the membership ID exists. When the membership record exists, the processor 11 determines to approve the shopping. When the membership record does not exist, the processor 11 determines not to approve the shopping.

If the processor 11 does not approve the shopping (“NO” in ACT3), the processor 11 ends the log-in as an error. In this case, an error is displayed on the touch panel 65 of the cart terminal 60, and the use of the cart terminal 60 is not allowed.

If the processor 11 approves the shopping (“YES” in ACT3), the processor 11 acquires the terminal ID set in the cart terminal 60 that has transmitted the login command (ACT4). For example, the processor 11 transmits a request command for the terminal ID to the cart terminal 60 that has transmitted the login command. The request command is transmitted from the access point 50 to the cart terminal 60 connected by the wireless LAN. The processor 61 of the cart terminal 60 that has received the request command wirelessly transmits the data of the terminal ID stored in the main memory 62. The data is sent to the sales promotion server 10 via the access point 50. Thereby, the processor 11 of the sales promotion server 10 can acquire the terminal ID. Hereinafter, for convenience of description, the terminal ID of the cart terminal 60 that has logged in will be referred to as a target terminal ID.

The processor 11 that has acquired the target terminal ID associates the target terminal ID with the member ID acquired in the processing in ACT2 (ACT5). The processor 11 then put these values in the association table 121. For example, the processor 11 puts the member ID and the target terminal ID in the same row of the association table 121.

When the association process between the member ID and the target terminal ID is finished, the processor 11 controls the communication interface 14 to output a start tracking notification to the tracking device 40 (ACT6). A start tracking notification command is output and transmitted from the communication interface 14 to the tracking device 40 through the communication network 70. The start tracking notification command includes the target terminal ID.

The processor 11 also controls the communication interface 14 to issue a start register notification to the virtual POS server 20 (ACTT). The processor 11 causes a start register notification command to be output from the communication interface 14 to the virtual POS server 20. The start register notification command is sent to the virtual POS server 20 through the communication network 70. The start trading notification command includes the target terminal ID. The order of the start tracking notification in ACT6 and the processing of the start register notification in ACTT may be interchanged, that is, the start register notification operation may be performed before the start tracking notification operation. In some cases, these processes may be performed simultaneously.

Upon receiving the start tracking notification command via the communication interface 45, the processor 41 of the tracking device 40 creates a flow line file FFL in the auxiliary storage device 43. The processor 41 includes the target terminal ID identified from the start tracking notification command in the area A1 of the flow line file FFL.

Then, the processor 41 waits for input of an information signal including the target terminal ID as the beacon information to the signal input circuit 46. Every time the corresponding information signal is input, the processor 41 acquires the position information of the beacon receiver 82 from the information signal. Further, the processor 41 acquires the time counted by the timepiece 44. The processor 41 adds the time and the position information in time series in the area A2 of the flow line file FFL for the target terminal ID in the area A1. In this way, the flow line data of the cart terminal 60, that is, the flow line data (movement tracking information) for the customer using the cart CR, is stored in the flow line file FFL.

When the processor 21 receives the start register notification command via the communication interface 24, the processor 21 creates a transaction information file TFL in the auxiliary storage device 23. Then, the processor 21 includes the target terminal ID from the start register notification command in the area B1 of the transaction information file TFL. The processor 21 also sets the status S1 of the area B4 to “0” as the first state.

After completion of the processing of the start tracking notification and the start register notification, the processor 11 determines whether commodity registration has been performed by the cart terminal 60 corresponding to the target terminal ID(ACT8). If commodity registration is not performed (“NO” in ACT8), the processor 11 determines whether an accounting instruction has been issued from the cart terminal 60 in which the target terminal ID is set (ACT9). If the accounting is not instructed (“NO” in ACT9), the processor 11 executes coupon processing (ACT10). Additional details of the coupon processing will be described later. Upon completion of the coupon processing, the processor 11 returns to ACT8. In ACT8 to ACT10, the processor 11 waits for the commodity registration to be performed or the settlement (accounting) instruction to be issued by the cart terminal 60. During the waiting period, the processor 11 repeatedly executes the coupon processing to evaluate if additional coupons can be issued.

The customer whose log-in has been authorized pushes the cart CR and moves around in the store. When the customer finds a commodity that he or she wishes to purchase, the customer scans a barcode of the commodity with the scanner 66 and places the commodity in the cart CR. When the barcode is held over the scanner 66, the data of the barcode is read by the scanner 66.

Once the processor 61 of the cart terminal 60 confirms that the barcode data has been read, the processor 61 controls the wireless device 64 to transmit a barcode input command to the virtual POS server 20. The barcode input command is wirelessly transmitted from the wireless device 64. The barcode input command is received at the access point 50 and sent to the virtual POS server 20 via the communication network 70. The barcode input command includes a target terminal ID and barcode data.

Upon receiving the barcode input command, the processor 21 of the virtual POS server 20 analyzes the barcode data of the command. When it is confirmed that the barcode data includes a commodity code, the processor 21 controls the communication interface 24 to transmit a commodity registration command to the sales promotion server 10 via the communication network 70. The commodity registration command includes a commodity code obtained from the barcode data.

Referring back to FIG. 12. Once the processor 11 of the sales promotion server 10, which is in the standby state in ACT8 and ACT9, receives the commodity registration command (“YES” in ACT8), the processor 11 retrieves the commodity code from the commodity registration command and acquires the data of the commodity identified by the commodity code (ACT11). For example, the processor 11 searches the commodity database 132 and acquires the commodity data of the commodity record 132R that includes the retrieved commodity code.

The processor 11 then controls the communication interface 14 to send a commodity registration notification to the virtual POS server 20 (ACT12). The commodity registration notification command is output and transmitted from the communication interface 14 to the virtual POS server 20 via the communication network 70. The commodity registration notification command includes data of the commodity record 132R, that is, commodity data such as a commodity code, a commodity name, a price, a sales floor code and the like. The processor 11 of the sales promotion server 10 that has transmitted the commodity registration notification command again enters the standby state in ACT8 and ACT9. During the standby state, the coupon processing is periodically executed.

When the processor 21 of the virtual POS server 20 receives the commodity registration notification command via the communication interface 24, the processor 11 acquires the commodity data from the commodity registration notification command. Then, the processor 21 generates commodity sales data on the basis of the commodity data. The processor 21 includes the commodity sales data in the area B2 of the transaction information file TFL for the target terminal ID listed in the corresponding area B1. Then, the processor 21 sets the status S1 of the area B4 to “1” in the second state. Further, the processor 21 outputs registered image data to the cart terminal from which a barcode input command has been sent. The registered image data is wirelessly transmitted to the cart terminal 60 via the access point 50. The registered image data includes commodity sales data of the transaction information file TFL.

The processor 61 of the cart terminal 60 that has received the registered image data causes the touch panel 65 to display the registered image. The registered image includes a commodity name, a price and the like of the commodity to be purchased. With the registered image displayed on the touch panel 65, the customer can confirm that the purchased commodity, of which the customer had scanned the barcode, has been correctly registered. The registration image includes an accounting button. The accounting button is a button image for the customer to instruct the accounting or checkout process to begin. The accounting button is an example of an operator that is reproduced on a screen by software.

The customer, who is ready for checking out or settlement processing of the registered item(s) touches the accounting button to finish shopping. Once the processor 61 of the cart terminal 60 detects that the accounting button has been touched, the processor 61 controls the wireless device 64 to transmit an accounting instruction command to the virtual POS server 20. The accounting instruction command is received at the access point 50 and sent to the virtual POS server 20 via the communication network 70. The accounting instruction command includes the target terminal ID.

Upon receiving the accounting instruction command, the processor 21 of the virtual POS server 20 controls the communication interface 24 to transmit an accounting command to the sales promotion server 10 via the communication network 70. The accounting command includes the target terminal ID.

Referring back to FIG. 12, when the processor 11 of the sales promotion server 10, which is in the standby state in ACT8 and ACT9, receives the accounting command (YES in ACT9), the processor 11 generates a unique accounting code (ACT13). For example, the processor 11 generates an accounting code by adding a series of numbers to the terminal ID included in the accounting command. When the accounting code is generated, the processor 11 controls the communication interface 14 to notify the virtual POS server 20 of the accounting code (ACT14). An accounting code notification command is output and transmitted from the communication interface 14 to the virtual POS server 20 via the communication network 70. The accounting code notification command includes the target terminal ID and the accounting code.

Upon receiving the accounting code notification command, the processor 21 of the virtual POS server 20 acquires the target terminal ID and the accounting code from the command. Then, the processor 21 puts the accounting code in the area B3 of the transaction information file TFL in which the target terminal ID is included in the area B1. At this time, the processor 21 sets the status S1 in the area B4 to “2” in the third state. Further, the processor 21 controls the communication interface 24 to output the accounting code to the cart terminal 60 from which the accounting instruction command has been transmitted. The data of the accounting code is output from the communication interface 24. The data of the accounting code received at the access point 50 is wirelessly transmitted from the access point 50 to the cart terminal 60.

Upon receiving the data of the accounting code, the processor 61 of the cart terminal 60 which has transmitted the accounting instruction command displays the accounting code on the touch panel 65. The accounting code is displayed, for example, in the form of a barcode.

The customer, who receives the accounting code, walks to an accounting machine 30, such as a POS terminal, a cash register, a self-service kiosk, or the like, located at, for example, a checkout counter or a self-service counter. Then, the customer uses a scanner of the accounting machine 30 to read the accounting code displayed on the touch panel 65. The data of the accounting code read by the accounting machine 30 is output to the virtual POS server 20.

Upon receiving the data of the accounting code from the accounting machine 30, the processor 21 of the virtual POS server 20 transmits the data of the transaction information file TFL (in which the accounting code is included) to the accounting machine 30 as accounting (settlement) data of the transaction. At this time, the processor 21 sets the status S1 of the area B4 to “3” indicating the fourth state.

In the accounting machine 30, when the accounting data of the transaction is acquired from the virtual POS server 20, the sales transaction can be settled (payment can be requested and made) based on the sales transaction data (that is, the list of registered commodities, the prices of the registered commodities, any applied coupon-based discounts, etc.).

When the settlement process in the accounting machine 30 ends, the processor 21 of the virtual POS server 20 controls the communication interface 24 to notify the sales promotion server 10 of the end of the transaction. An end tracking notification command is also transmitted from the communication interface 24 to the sales promotion server 10 via the communication network 70. The end tracking notification command includes the target terminal ID.

Referring back to FIG. 12, the processor 11 of the sales promotion server 10 that has notified the virtual POS server 20 of the accounting code (ACT14) waits for the end tracking notification (ACT15). Upon receiving the end tracking notification command (YES in ACT15), the processor 11 controls the communication interface 14 to notify the tracking device 40 of the end of tracking (ACT16). An end tracking command is output and sent from the communication interface 14 to the tracking device 40 via the communication network 70. The end tracking command includes the target terminal ID.

Upon receiving the end tracking command, the processor 41 of the tracking device 40 acquires the target terminal ID from the received command. Then, the processor 41 closes the flow line file FFL for which the target terminal ID is included in the area A1. This completes the information processing shown in FIG. 12 (END).

In some instances, a customer decides whether to purchase a product by looking at it, examining it, or admiring it on the sales floor. A customer who is actively considering whether or not to purchase a product will tend to stay in front of a sales display of the product, a shelf location at which the product is stored, or aisle location corresponding to the product on the sales floor for a longer time to make a purchase decision. In other instances, a customer may leave the product's sales floor location, only to return again to the same spot as part of the purchase decision process. Such behaviors of a customer can be recognized by analyzing a flow line or a movement line of a customer being tracked by the tracking device 40 of the sales promotion system 100. In the present embodiment, to a customer who shows such specific behaviors while shopping, a coupon that can be used for a commodity which the customer wishes to purchase (herein, may also be referred to as a purchase-desired commodity) is issued on the spot as sales promotion. For the coupon issuance as sales promotion, the coupon processing (ACT10) is periodically executed while the processor 11 of the sales promotion server 10 waits for the commodity registration and the accounting instruction (ACT8 and ACT9).

FIG. 13 is a flowchart illustrating a procedure of coupon processing. Upon entering the coupon processing stage, the processor 11 acquires the transaction information file TFL corresponding to the target terminal ID from the virtual POS server 20 (ACT31). The processor 11 also acquires the flow line file FFL of the target terminal ID from the tracking device 40 (ACT32). The order of the processing in ACT31 and the processing in ACT32 may be interchanged, that is, the acquisition of the flow line file FFL can be performed before the acquisition of the transaction information file TFL. In some cases, these two processes may be performed simultaneously.

The processor 11 detects the sales floor location where the customer is presently located based on the flow line data in area A2 of the flow line file FFL (ACT33). For example, first, the processor 11 determines the sales floor location specified by the sales floor code included in the position information of the latest flow line data as the present sales floor location (ACT33). The processor 11 calculates a continuous stay time T1 for the present sales floor location (ACT34). For example, the processor 11 detects the sales floor code included in the position information of each piece of the flow line data by analyzing from the latest flow line data and the older flow line data in order. Then, the processor 11 calculates an elapsed time at the present location from the time of the flow line data until the cart CR is moved to a sales floor location corresponding to a different sales floor code. This elapsed time is the continuous stay time T1 (that is, the time the cart CR has remained at the present sales floor location without leaving).

The processor 11 determines whether the continuous stay time T1 exceeds a first threshold time Tx (ACT35). The first threshold time Tx is arbitrarily set to be long enough to assume that a customer staying at the sales floor location is considered whether to purchase a commodity at that sales floor location. In the present embodiment, the first threshold time Tx may be set to, for example, 30 seconds. Tx may be shorter or longer than 30 seconds, such as 20 seconds, 1 minute, or the like, taking into consideration various factors of a commodity, sales floor location, store characteristics, and the like.

If the continuous stay time T1 does not exceed the first threshold time Tx (“NO” in ACT35), the processor 11 calculates a cumulative stay time T2 for the sales floor location (ACT36).

For example, first, the processor 11 detects the sales floor code included in the position information of each piece of the flow line data by analyzing from the flow line data until the present sales floor code switches to another sales floor code. Then, each time the processor 11 detects the sales floor code included in the position information of the latest flow line data has changed, the processor 11 tracks a total time Tn at the sales floor code. The processor 11 tracks a cumulative time for which the cart CR is at each sales floor code location by adding the continuous stay time T1 to time Tn for that sales floor code to calculate the cumulative stay time T2.

The processor 11 determines whether the cumulative stay time T2 has exceeded a second threshold time Ty (ACT37). The second threshold time Ty is set to be long enough to assume that a customer who left a sales floor location and then returns to the same sales floor location is considering whether to purchase a commodity at that sales floor location. The second threshold time Ty may be longer than the first threshold time Tx. In the present embodiment, the second threshold time Ty is set to, for example, 45 seconds. Ty may be shorter or longer than 45 seconds, such as 40 seconds, 2 minutes, or the like, taking into consideration various factors of a commodity, a sales floor location, a store, and the like.

If the cumulative stay time T2 does not exceed the second threshold time Ty (“NO” in ACT37), the processor 11 ends the coupon processing. Therefore, if the continuous stay time T1 does not exceed the first threshold time Tx and the cumulative continuous stay time T2 does not exceed the second threshold time Ty, then a coupon will not be issued to that customer.

On the other hand, if the continuous stay time T1 exceeds the first threshold time Tx (“YES” in ACT35), or if the cumulative stay time T2 exceeds the second threshold time Ty (“YES” in ACT37), the processor 11 determines whether a commodity sold at the present sales floor location has already been purchased (ACT38). For example, first, the processor 11 searches the commodity sales data in the area B2 of the transaction information file TFL. Then, if the processor 11 detects commodity sales data including the sales floor code of the present sales floor location, the processor 11 determines that a relevant commodity has already been purchased (“YES” in ACT38) and ends the coupon processing. Therefore, even if the continuous stay time T1 exceeds the first threshold time Tx or the cumulative stay time T2 exceeds the second threshold time Ty, no coupon is issued to the customer who has already purchased a commodity sold at the present sales floor location.

If the processor 11 determines that such a commodity has not yet been purchased (“NO” in ACT38), the processor 11 finds a coupon to be suggested to the customer (ACT39). For example, first, the processor 11 searches the coupon database 133 for the sales floor code of the present sales floor location. Then, the processor 11 checks for a coupon record 133R that includes the sales floor code of the present sales floor location. If the corresponding coupon record 133R does not exist in the coupon database 133, the processor 11 determines that there is no coupon to be presented.

If the coupon record 133R that includes the sales floor code of the present sales floor location exists in the coupon database 133, the processor 11 acquires the member ID associated with the terminal ID by reference to the association table 121. The processor 11 can further acquire the gender and age or the like of a customer (who is a member) from the member database 131 corresponding to the member ID.

The processor 11 determines whether the gender and age of the member belong to the target customer layer of the coupon record 133R. If the gender and age of the member do not meet the target customer parameters, the processor 11 determines that there is no coupon to be issued. If the gender and age of the member belong to the target customer layer, the processor 11 determines that there is a coupon to be issued. The coupon to be issued is, for example, a coupon that applies a price reduction or a price discount to the commodity that is sold in the customer's present sales floor location and that is targeted to the customer category to which the customer belongs.

If there is no coupon to be issued (“NO” in ACT40), the processor 11 ends the coupon processing.

If there is a coupon to be provided (“YES” in ACT40), the processor 11 acquires the coupon image from the coupon record 133R of the coupon to be issued (ACT41). Then, the processor 11 controls the communication interface 14 to output the data of the coupon image to the cart terminal 60 in which the target terminal ID has been set. The data of the coupon image is wirelessly transmitted via the access point 50 and is received by the cart terminal 60 Once the cart terminal 60 has received the data of the coupon image, the cart terminal 60 displays the coupon image on the touch panel 65. The coupon image 90 as shown in FIG. 8 is one example.

The customer confirms the coupon image 90 displayed on the touch panel 65 and determines whether to use the coupon. In some instances, a plurality of customers may use coupons and purchase commodities to which the coupons are applied. In the case of coupon image 90 (FIG. 8), to use the coupon, the customer touches the “Yes” button image BT1. In addition, the customer scans the barcode of the commodity with the scanner 66. Then, a signal indicating that the button image BT1 has been touched is transmitted from the cart terminal 60 to the sales promotion server 10. Further, the barcode input command including the commodity code is transmitted from the cart terminal 60 to the virtual POS server 20. If the customer touches the “No” button image BT2, a signal indicating that the button image BT2 has been touched is transmitted from the cart terminal 60 to the sales promotion server 10.

The processor 11 of the sales promotion server 10 that has output the coupon image data adds the issue frequency of the coupon record 133R by “1” (ACT42). Then, the processor 11 waits for a signal from the cart terminal 60 (ACT43). When the processor 11 receives the signal indicating that the button image BT2 has been touched (“NO” in ACT43), the processor 11 ends the coupon processing.

When the processor 11 receives a signal indicating that the button image BT1 has been touched (“YES” in ACT43), the processor 11 acquires coupon data from the coupon record 133R (ACT44) and controls the communication interface 14 to notify the virtual POS server 20 of the coupon data. The coupon data is output and sent from the communication interface 14 to the virtual POS server 20 via the communication network 70.

The processor 11 of the sales promotion server 10 that has output the coupon data adds the usage frequency of the coupon record 133R by “1” (ACT45). This completes the coupon processing by the sales promotion server 10.

Once the processor 21 of the virtual POS server 20 has received the coupon data from the sales promotion server 10, the processor 21 acquires the data for identifying the coupon target commodity and the data of the price reduction or the price discount from the coupon data. Then, the processor 21 determines whether the commodity specified by the commodity code included in the barcode input command received from the cart terminal 60 of the target terminal ID is the coupon target commodity. In the case where the commodity is the coupon target commodity, the processor 21 applies the price reduction or price discount to the commodity. For example, when the coupon data indicating a 20% discount, the processor 11 performs a registration process of the commodity sales data by subtracting the price of the commodity by 20%.

The processor 11 of the sales promotion server 10 executes the processing of ACT31 to ACT37 in FIG. 13, thereby functioning as a prediction unit that predicts a purchase-desired commodity (that is a commodity which a customer wishes to purchase) from behaviors of a customer during his or her shopping.

In ACT31, the processor 11 acquires the information stored in the commodity database 132, and in ACT32, the processor 11 acquires the flow line data of the customer tracked by the tracking device 40.

Then, in ACT33 to ACT37, the processor 11 predicts the purchase-desired commodity of the customer from the information of the commodity database 132 and the flow line data. In ACT33 to ACT35, the processor 11 identifies a sales floor location where the customer dwells for at least a certain period of time based on the flow line (tracked movement) of the customer and predicts the purchase-desired commodity. In ACT36 and ACT37, when the cumulative stay time at the identified sales floor location exceeds a predetermined time, the processor 11 predicts the purchase-desired commodity based on the flow line of the customer.

Then, the processor 11 executes the processing in ACT38 to ACT41 of FIG. 13, thereby functioning as a coupon issuing unit that provides or issues a coupon as the sales promotion information on the predicted commodity. The processor 11 also functions as an acquisition unit that acquires the information about the commodity purchased by the customer by executing the processing in ACT38. Then, when the customer dwells at the same sales floor for at least a predetermined period of time, the processor 11 provides the sales promotion information in a case where the customer has not purchased a commodity at the sales floor location during the predetermined period of time. Alternatively, when the cumulative stay time at one location exceeds a predetermined period of time, the sales promotion information is provided in a case where the customer has not purchased the commodity at the sales floor location.

In the sales promotion system 100 according to the present embodiment, a coupon is issued as sales promotion information to a customer who is wondering whether to purchase a commodity or not. This coupon, once issued, is likely to be used for such a commodity, and hence, the customer will increase his or her desire to purchase the commodity. As a result, many customers use coupons to purchase commodities, and sales are effectively promoted.

Hereinafter, some modified embodiments will be described.

In the present embodiment, the beacon transmitter 81 is provided in the cart CR, and a beacon receiver 82 is provided in each sales floor location. In another embodiment, a beacon receiver may be provided in the cart CR, and a beacon transmitter may be provided in each sales floor location. In this case, the tracking device 40 acquires the information signal of the beacon from the cart terminal 60.

The flow line tracking of a customer may also be performed in a manner other than utilizing a beacon. For example, cameras may be arranged in the store, and flow lines of each customer may be tracked from images taken by the cameras. Other methods may be applied to track the movement of the customers about the store.

In the present embodiment, the sales promotion information to be provided is a coupon that offers a price reduction or a price discount of a commodity which is being sold at a sales floor location where a customer dwells for a predetermined period of time, provided that the commodity promotion has a target customer category to which the customer belongs. In another embodiment, a coupon of a commodity being sold at a sales floor location where a customer has simply stopped for some amount of time may be provided. In still another embodiment, a cash voucher, a price reduction ticket, a price discount ticket or the like may be issued regardless of a commodity type or location. The type or content of sales promotion information is not particularly limited as long as the sales promotion information can encourage a customer to purchase a commodity when the customer is wondering or hesitating about buying a commodity.

In the present embodiment, the sales promotion information is provided to a customer who has not yet purchased a commodity being sold at the sales floor location at which the deemed purchase-desired commodity is being displayed. In another embodiment, the promotion information may be provided regardless of whether a commodity has already been purchased or not at the sales floor location.

In the present embodiment, the sales promotion information is sent to the cart terminal 60. In another embodiment, the sales promotion information may be provided to an information terminal such as a smartphone carried by a customer.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales promotion system, comprising:
a sales promotion sever including a first processor configured to:
identify a product at a sales floor location as a purchase-desired commodity for a customer based on movements of the customer on a sales floor during shopping; and
provide sales promotion information related to the purchase-desired commodity to the customer while the customer is at the sales floor location.

2. The sales promotion system according to claim 1, further comprising:
a flow-line tracking apparatus including a second processor configured to:
receive position data corresponding to a sales floor location of the customer during shopping;
store the received position data for the customer in time series; and
send the stored position data for the customer to the sales promotion server.

3. The sales promotion system according to claim 2, wherein the movements of the customer on the sales floor during shopping are provided by the position data sent by the flow-line tracking apparatus.

4. The sales promotion system according to claim 1, wherein the first processor is further configured to:
identify the product as the purchase-desired commodity for the customer based on the customer remaining at the sales floor location for the product for a predetermined continuous length of time.

5. The sales promotion system according to claim 1, wherein the first processor is further configured to:
identify the product as the purchase-desired commodity for the customer based on the customer being at the sales floor location for the product for a predetermined cumulative length of time.

6. The sales promotion system according to claim 1, further comprising:
a customer terminal configured to permit the customer to register items for a sales transaction and generate sales transaction data including a list of items registered in the sales transaction, wherein
the first processor is configured to provide the sales promotion information related to the purchase-desired commodity only if the sales transaction data does not indicate an item located at the sales floor location has been registered in the sales transaction.

7. The sales promotion system according to claim 6, wherein the customer terminal is mounted on a shopping cart.

8. The sales promotion system according to claim 1, further comprising:
a commodity database storing commodity records for products being sold on the sales floor, the commodity records including information corresponding to a sales floor location of each product.

9. The sales promotion system according to claim 1, further comprising:
a sales promotion database storing sales promotion information that is associated with particular sales floor locations on the sales floor, wherein
the first processor provides the sales promotion information related to the purchase-desired commodity to the customer by referencing to the sales promotion database.

10. A sales promotion sever, comprising:
a first processor configured to:
identify a product at a sales floor location as a purchase-desired commodity for a customer based on movements of the customer on a sales floor during shopping; and
provide sales promotion information related to the purchase-desired commodity to the customer while the customer is at the sales floor location.

11. The sales promotion server according to claim 10, further comprising:
a communication interface configured to receive position data for the customer from a flow-line tracking apparatus, wherein
the movements of the customer on the sales floor during shopping are provided by the position data received from the flow-line tracking apparatus.

12. The sales promotion server according to claim 10, wherein the first processor is further configured to:
identify the product as the purchase-desired commodity for the customer based on the customer remaining at the sales floor location for the product for a predetermined continuous length of time.

13. The sales promotion server according to claim 10, wherein the first processor is further configured to:
identify the product as the purchase-desired commodity for the customer based on the customer being at the sales floor location for the product for a predetermined cumulative length of time.

14. The sales promotion server according to claim 10, wherein the processor is configured to provide the sales promotion information related to the purchase-desired commodity only if sales transaction data associated with the customer does not indicate an item located at the sales floor location has been registered in a sales transaction.

15. The sales promotion server according to claim 10, further comprising:
a commodity database storing commodity records for products being sold on the sales floor, the commodity records including information corresponding to a sales floor location of each product.

16. The sales promotion server according to claim 10, further comprising:
a sales promotion database storing sales promotion information that is associated with particular sales floor locations on the sales floor, wherein
the processor provides the sales promotion information related to the purchase-desired commodity to the customer by referencing to the sales promotion database.

17. A sales promotion system, comprising:
a commodity database to store commodity records, the commodity records including product information for each product being sold on a sales floor, the product information including a particular sales floor location at which the product is located on the sales floor;
a coupon database to store coupon records, the coupon records including coupon information for products associated with particular sales floor locations; and
a processor configured to:
track movement of a customer on the sales floor by sales floor location during shopping,
based on the tracked movement of the customer, identify a first sales floor location at which the customer dwells for greater than a predetermined period,
identify a purchase-desired commodity in the commodity database for the customer based on the first sales floor location, and
issue a coupon related to the purchase-desired commodity based on the coupon information in the coupon database.

18. The sales promotion system according to claim 17, wherein the first sales floor location is identified based on a continuous dwell time of the customer at the first sales floor location.

19. The sales promotion system according to claim 17, wherein the first sales floor location is identified based on a cumulative dwell time of the customer at the first sales floor location, the cumulative dwell time comprising two or more periods of continuous dwell times at the first sales floor location by the customer.

20. The sales promotion system according to claim 19, wherein the processor issues the coupon only if sales transaction data associated with the customer does not indicate a product located at the first sales floor location has been registered in a sales transaction.
